(19) United States
(12) Patent Application Publication
(10) Pub. No.: US 2026/0337884 A1
(43) Pub. Date: Oct. 29, 2026

(54) MOISTURE MODULATING MATERIALS AND METHODS

(71) Applicant: BAMBAX LIMITED, Hamilton (NZ)

(72) Inventors: Cameron BARTLEY, Hamilton (NZ); Peter LEE, Hamilton (NZ); Callum WINDLEY, Hamilton (NZ)

(21) Appl. No.: 19/490,323

(22) PCT Filed: Jun. 7, 2024
(86) PCT No.: PCT/NZ2024/050065

§ 371 Date: Dec. 4, 2025

(30) Foreign Application Priority Data
Jun. 9, 2023 (AU) 2023901833

(51) Int. Cl. D21H 17/68; D21H 19/12; D21H 19/40; D21H 19/52; D21H 19/82; D21H 27/10

(52) U.S. Cl. CPC D21H 17/68; D21H 19/12; D21H 19/40; D21H 19/52; D21H 19/82; D21H 27/10

(57) ABSTRACT

The present invention relates generally to moisture vapour transmission modulators and/or humidity control materials, and more particularly but not necessarily exclusively, to compositions for decreasing the moisture vapour transmission rate and/or humidity control and their method of use. In some forms, the composition of the invention may be applied to a material. Such materials may be used in packaging goods prone to spoilage such as food. Such materials may be used to reduce or prevent degradation of or damage to packaged electronics, pharmaceuticals, and dry products such as paper (so as to prevent curl in copy paper). Such materials may be used to form packaging that may otherwise be weakened by the action of liquids such as water.

### FIELD OF THE INVENTION

The present invention relates generally to moisture vapour transmission modulators and/or humidity control materials, and more particularly but not necessarily exclusively, to compositions for decreasing the moisture vapour transmission rate and/or humidity control and their method of use. In some forms, the composition of the invention may be applied to a material. Such materials may be used in packaging goods prone to spoilage such as food. Such materials may be used to reduce or prevent degradation of or damage to packaged electronics, pharmaceuticals, and dry products such as paper (so as to prevent curl in copy paper). Such materials may be used to form packaging that may otherwise be weakened by the action of liquids such as water.

### BACKGROUND TO THE INVENTION

A high relative humidity environment can facilitate the growth of microorganisms such as bacteria and mould. Even under cold conditions, a high relative humidity presents problems as moisture can result in unwanted ice crystals being formed on a product. In both cases, where the product is food, accelerated spoilage will usually occur.

Numerous approaches to shielding a product from the impact of environmental moisture have been taken.

One such approach is to use product packaging that provides a moisture barrier, such as sealed metal packaging, hard plastic packaging, or soft plastic packaging. In each case the product packaging is a disposable item and will typically not decompose. Whilst the recycling of some of these forms of packaging may reduce the environmental impact of the use of that packaging, inevitably some of the material will enter landfill and that waste compounds over time. Even relatively cheap disposable materials such as polyethylene that are used to provide soft plastic packaging are not impervious to moisture. While some biodegradable packaging materials are becoming more widely used, most are expensive and have poor moisture barrier properties.

The ability of a material for product packaging to protect contents from environmental moisture is typically referred to as their moisture vapor transmission rate (MVTR). That rate is determined by measuring its resistance to moisture penetrating the packaging material under a constant pressure. Whilst it may be generally considered that a plastic barrier is impermeable to water vapour, some low-density polyethylene films may have a MVTR of as much as 16-23 g/m²/24 hr for films having a thickness of about 25 microns. For reference, an aluminium foil laminate may have a MVTR of 0.001 g/m²/24 hr, this being effectively impermeable to water vapour.

However, in some instances, it may be preferable that the packaging allows for moisture vapour to pass through and that the product within the packaging is not sealed within the packaging. An example of this is when the product itself is hygroscopic and can release water vapour upon increasing temperatures, e.g. tomatoes. In such instances, if the temperature increases then the water vapour from the product may condense within the packaging and damage the product. Accordingly, the desiccant and as well as the packing material need to be carefully selected based on the properties of the product. It is therefore desirable to be able to modulate the moisture barrier properties of a packaging product, depending on the product to be packaged.

Another approach to reducing the impact of environmental moisture on packaged products, which is often used in combination with the use of a packaging material that provides some degree of a moisture barrier, is to include a dessicant material within the packaging. The dessicant will typically compete with the product for absorbing moisture and reduce spoilage. Existing desiccants have limited capacity for absorbing water before the desiccant is saturated, and once saturated further absorption of water is not possible.

Existing desiccants are provided in the form of tablets, sachets, and dry powders. A common example in the art of this is silica gel in the form of spherical beads packaged into a sachet which is placed into a package so it can absorb moisture that enters the package. Desiccants in such forms can be accidentally ingested or can be aerosolised upon handling which presents a health risk, that varies depending on the nature of the desiccant. Other more effective desiccants such as calcium chloride become liquid at high humidities and can cause damage.

Another problem that arises with the use of absorbent or adsorbent packaging materials is that their structural integrity may be reduced upon exposure to moisture. For example, the ubiquitous corrugated cardboard packaging provides a relatively strong packaging material when it is dry. However, upon exposure to moisture—even small quantities of moisture—can dramatically reduce its structural integrity. One previous approach to reducing the impact of moisture on such packaging is to laminate or impregnate the cardboard with a moisture resistant material such as a synthetic polymer or a wax.

However laminating or impregnating the cardboard with such materials will generally render the cardboard as non-recyclable, may be relatively expensive to implement, and also may still leave sufficient of the cardboard unlaminated that water will ingress and then readily wick through the material.

It is an object of the invention to provide a packaging material that reduces the impact of moisture on the contents of the packaging material.

It is an object of the invention to provide a biodegradable packaging material that reduces the impact of moisture on the contents of the packaging material.

It is an object of the invention to provide a method of treating a material to reduce the impact of moisture on the material.

It is an object of the invention to provide a method of treating a packaging material to reduce the impact of moisture on the material.

Alternatively, it is an object of the technology to at least provide the public with a useful choice.

### SUMMARY OF THE INVENTION

In a first aspect the invention provides a material (such as a packaging material, fabric or building material) including a matrix of fibres, the matrix including at least one (such as two of the following, such as three of the following) of the following:
i. a hygroscopic salt which is adsorbed onto the surface of the fibres, the hygroscopic salt being water soluble;
ii. a phyllosilicate mineral; and
iii. a cellulosic particle which can be entrained within the matrix.

Preferably the cation of the hygroscopic salt is selected from calcium, magnesium, aluminium, potassium, sodium, zinc, and lithium, and combinations thereof.

Preferably the cellulosic particle is selected from the group consisting of: a micro-fibrillated cellulose, microcrystalline cellulose, and nano-structured cellulose, and combinations thereof.

In embodiments where the matrix includes a hygroscopic salt which is adsorbed onto the surface of the fibres, the hygroscopic salt being water soluble, the material may also include a water insoluble (or poorly soluble) hygroscopic salt. An example of an insoluble hygroscopic salt which may be used in the present invention is calcium sulfate (hemihydrate and/or dihydrate, preferably hemihydrate). The water insoluble (or poorly soluble) hygroscopic salt may be entrained within the matrix of fibres.

Preferably the invention relates to a matrix of fibres (such as may be found in a packaging material, fabric or building material) that includes a hygroscopic salt adsorbed to the surface of the fibres, the hygroscopic salt being water soluble (preferably wherein the cation of the hygroscopic salt is selected from calcium, magnesium, aluminium, potassium, sodium, zinc, and lithium, and combinations thereof), and the material (such as a packaging material, fabric or building material) further includes at least one of:
i. a phyllosilicate mineral; and
ii. a cellulosic particle which can be entrained within the matrix (preferably wherein the cellulosic particle is selected from the group consisting of: a micro-fibrillated cellulose, microcrystalline cellulose, and nano-structured cellulose, and combinations thereof).

Preferably the invention relates to a matrix of fibres (such as may be found in a packaging material, fabric or building material) that includes a hygroscopic salt adsorbed to the surface of the fibres, the hygroscopic salt being water soluble (preferably wherein the cation of the hygroscopic salt is selected from calcium, magnesium, aluminium, potassium, sodium, zinc, and lithium, and combinations thereof) and the material (such as a packaging material or building material) further includes each of:
i. a phyllosilicate mineral; and
ii. a cellulosic particle which can be entrained within the matrix (preferably wherein the cellulosic particle is selected from the group consisting of: a micro-fibrillated cellulose, microcrystalline cellulose, and nano-structured cellulose, and combinations thereof).

It has been discovered that the use of a hygroscopic salt that is water soluble (such as having a cation selected from calcium, magnesium, aluminium, potassium, sodium, zinc, and lithium, and combinations thereof) adsorbed to a matrix of fibres provides a decreased moisture vapour transmission rate compared with the same material that lacks the hygroscopic salt.

It has been discovered that the use of a phyllosilicate mineral applied to a matrix of fibres provides a decreased moisture vapour transmission rate compared with the same material that lacks the phyllosilicate mineral.

It has been discovered that the use of a cellulosic particle (selected from the group consisting of: a micro-fibrillated cellulose, microcrystalline cellulose, and nano-structured cellulose, and combinations thereof) applied to a matrix of fibres provides a decreased moisture vapour transmission rate compared with the same matrix that lacks the particle.

However, it has been further discovered that the combined use of any two or more—preferably all three—of the hygroscopic salt, phyllosilicate mineral, and cellulosic particle applied to a material so that the hygroscopic salt is adsorbed to the matrix of fibres provides a decreased moisture vapour transmission rate compared with the same matrix without that combination. In some embodiments the use of any two or more, or all three of the components provides a synergistic decrease in the moisture vapour transmission rate compared with the same matrix without that combination in a manner that could not have been contemplated based merely on an additive effect.

Without wishing to be bound by theory, it is believed that the hygroscopic salt functions to adsorb water, while the phyllosilicate mineral and cellulosic particle not only decrease the moisture transmission rate themselves but synergistically assist with dispersing the hygroscopic salt across the matrix.

The material (such as a packaging material, fabric or building material) of the invention may be further provided as a composite material, such as further including a layer of polymer, such as biodegradable polymer. It will be appreciated that such a composite material may be referred to as having a sandwich construction. The material (such as a packaging material, fabric or building material) of the present invention may form part of a composite material together with other layers used in the packaging industry such as printed layers, compacted layers, etc.

In a second aspect the invention provides a coating system for applying to a material including a matrix of fibres to decrease moisture vapour transmission across said material, the coating system including at least two of the following compositions (such as each of the following components):
a composition including: a hygroscopic salt which is water soluble (preferably wherein the cation of the hygroscopic salt is selected from calcium, magnesium, aluminium, potassium, sodium, zinc, and lithium, and combinations thereof); and a first carrier;
a composition including: a phyllosilicate mineral; and a second carrier; and
a composition including: a cellulosic particle which can be entrained within the matrix (preferably selected from the group consisting of: a micro-fibrillated cellulose, microcrystalline cellulose, and nano-structured cellulose, and combinations thereof); and a third carrier.

In embodiments where the coating system includes a hygroscopic salt which is water soluble, the composition may also include a water insoluble (or poorly soluble) hygroscopic salt. An example of an insoluble hygroscopic salt which may be used in the present invention is calcium sulfate (hemihydrate and/or dihydrate, preferably hemihydrate). The water insoluble (or poorly soluble) hygroscopic salt may be entrained within the matrix of fibres.

The coating system may also include a polymer (such as a biodegradable polymer) and a fourth carrier.

The first carrier, second carrier, third carrier, and fourth carrier may each be the same or different and may be selected from any carrier suitable for dispersing the hygroscopic salt, the phyllosilicate mineral, the cellulosic particle, or the polymer (respectively). In some embodiments the first carrier, the second carrier, the third carrier, and the fourth carrier are independently selected from an aqueous carrier, such as water.

In a third aspect the invention provides a method of treating a material including a matrix of fibres to decrease moisture vapour transmission across said material, the method including the steps of:
i. providing a material including a matrix of fibres;
ii. applying a first composition to the material, the composition including a first carrier and at least one of:
   a. a hygroscopic salt which is water soluble (preferably having a cation selected from calcium, magnesium, aluminium, potassium, sodium, zinc, and lithium, and combinations thereof);
   b. a phyllosilicate mineral; and
   c. a cellulosic particle which can be entrained within the matrix (preferably selected from the group consisting of: a micro-fibrillated cellulose, microcrystalline cellulose, and nano-structured cellulose, and combinations thereof);
iii. removing at least a portion of the first carrier from the material.

In embodiments where the method includes the step of applying a hygroscopic salt which is water soluble, the method may also include a step of applying a water insoluble (or poorly soluble) hygroscopic salt. An example of an insoluble hygroscopic salt which may be used in the present invention is calcium sulfate (hemihydrate and/or dihydrate, preferably hemihydrate). The water insoluble (or poorly soluble) hygroscopic salt may be entrained within the matrix of fibres.

The method of the third aspect will typically coat at least a portion of the material with the hygroscopic salt, phyllosilicate material, and/or particle. Where used, at least a portion of the hygroscopic salt will typically be adsorbed to at least a portion of the matrix of fibres of the material. In some cases, at least a portion of the hygroscopic salt will be adsorbed to: at least a portion of the matrix of fibres of the material; and at least a portion of the particle where the particle is used.

The method of the third aspect may include one or more additional coating step(s)). The or each additional coating step(s) may independently include the steps of:
i. applying a second composition to the material to which the first composition has been applied, the composition including a second carrier and at least one of:
   a. a polymer (such as a biodegradable polymer and/or recyclable polymer);
   b. a hygroscopic salt (preferably having a cation selected from calcium, magnesium, aluminium, potassium, sodium, zinc, and lithium, and combinations thereof);
   c. a phyllosilicate mineral; and
   d. a cellulosic particle which can be entrained within the matrix (preferably selected from the group consisting of: a micro-fibrillated cellulose, microcrystalline cellulose, and nano-structured cellulose, and combinations thereof);
ii. removing at least a portion of the second carrier from the material.

It will be appreciated that the additional coating step(s) may be undertaken iteratively, any number of times, so as to provide a composite material that may include a plurality of layers. For example, the additional coating step may be undertaken once, twice, three times, four times, or five times.

The present inventors have realised that by using the material of the invention system in combination with a polymer coating it is possible to reduce the amount of polymer used in the final coated product. For instance, a material coated in a traditional polymer coating may only be able to decrease the moisture transmission by a rate X when the polymer coating is provided at a coverage of Y gsm. By incorporating the hygroscopic salt/phyllosilicate mineral/cellulosic particle the material may only need less than Y gsm coverage of the polymer to achieve the same (or better) MVTR X.

Where provided, a layer including a biodegradable polymer is preferably provided last in the iterative coating steps so that the biodegradable polymer is provided at an extremity of the composite material, rather than being interposed (sandwiched) between the outer extremity layers. By positioning the biodegradable polymer at an extremity it may be allowed to contact a packaged product such as food, for example. When used in a package, such an extremity may be internal to the package. Such a biodegradable polymer may have a thickness of the order of less than 50 microns, such as less than 20 microns, such as about 5 to 10 microns.

In a fourth aspect, the invention provides a package being formed, at least in part, from a packaging material, the packaging material including a matrix of fibres, the matrix including at least one (such as two of the following, such as three of the following) of the following:
i. a hygroscopic salt which is adsorbed onto the surface of the fibres, the hygroscopic salt being water soluble (preferably the cation of the salt is selected from calcium, magnesium, aluminium, potassium, sodium, zinc, and lithium, and combinations thereof);
ii. a phyllosilicate mineral; and
iii. a cellulosic particle which can be entrained within the matrix (preferably the particle being selected from the group consisting of: a micro-fibrillated cellulose, microcrystalline cellulose, and nano-structured cellulose, and combinations thereof).

In embodiments where the package includes a hygroscopic salt which is water soluble, the package may also include a water insoluble (or poorly soluble) hygroscopic salt. An example of an insoluble hygroscopic salt which may be used in the present invention is calcium sulfate (hemihydrate and/or dihydrate, preferably hemihydrate). The water insoluble (or poorly soluble) hygroscopic salt may be entrained within the matrix of fibres.

Preferably the package of the fourth aspect is recyclable and/or biodegradable.

The package (and packaging material from which it is made) of the fourth aspect may provide a number of advantages.

One advantage may be provided where the package forms an enclosure so that the contents of the package can be sealed from the environment external of the package to the contents. In such an example, the packaging material will provide a decreased moisture vapour transmission rate compared with the same material that lacks the hygroscopic salt; phyllosilicate mineral; and cellulosic particle. In practical terms, this function provides the contents of the enclosed package will retain a substantially constant moisture level over a period of time. Where that contents is a product prone to spoilage, such as food, the shelf-life of the product may be increased. In some embodiments, the environment external of the package to the contents will have a higher relative humidity than the environment internal of the package. In some embodiments, the environment external of the package to the contents will have a lower relative humidity than the environment internal of the package. In some embodiments the relative humidity of the environment external of the package to the contents will fluctuate (such as through a diurnal cycle or warming and cooling) between a higher relative humidity and a lower relative humidity compared with the environment internal of the package. In some or all of these embodiments it will generally be an advantage to decrease the moisture vapour transmission rate through a packaging material so as to retain the qualities of the contents of the package in a condition similar to those when first enclosed in the package.

One advantage may be provided where the packaging material provides superior mechanical properties when relatively dry, and inferior mechanical properties if it becomes wet or at least wetter. Such wetting may occur through a number of mechanisms: such as a single incident of being contacted with a liquid such that the liquid wicks through the material; or such as through fluctuating temperature and/or relative humidity conditions that gradually expose the material to wetting conditions. In each or any case it would be appreciated that being able to reduce the exposure of the material to moisture would lead to the material retaining the superior mechanical properties for longer. The present invention provides a packaging material that provides a decreased moisture vapour transmission rate compared with the same material that lacks the hygroscopic salt; phyllosilicate mineral; and/or cellulosic particle, which in turn will typically lead to a reduced exposure of the material to moisture. In this way the use of the hygroscopic salt; phyllosilicate mineral; and/or cellulosic particle provides a type of modified atmosphere package, namely a type of packaging system in which the atmospheric composition inside the package is altered from the normal air composition to extend the shelf life of perishable products. In this case the modification is to relative humidity. Two examples of packaging that benefits mechanically from the present invention are detailed below.

In the first example, where the material is corrugated cardboard packaging used in box manufacture, it will be appreciated that the mechanical properties of such cardboard will be superior when it is dry compared with when it is wetted. Advantageously, by applying the hygroscopic salt; phyllosilicate mineral; and/or cellulosic particle to the cardboard, the rate of transmission of environmental moisture through the cardboard material will be decreased and hence the superior mechanical properties will be sustained for a greater period of time than in the absence of the hygroscopic salt; phyllosilicate mineral; and/or cellulosic particle. Cardboard packaging in particular (but also many other forms of packaging to which the present invention is suited) is typically over-engineered so as to account for the assumed loss of mechanical strength as a result of exposure to moisture over time. Another advantage of reducing the rate of transmission of environmental moisture through the cardboard material using the present invention is that the cardboard packaging may be designed more efficiently since it does not need to be over-engineered to the same extent.

In the second example, where the material is a laminated cellulosic material used to package liquids, such as marketed by the international company Tetra Pak®, it is a recognised problem that over time the core cellulosic material becomes increasingly more exposed to moisture from the liquid contents of the package and/or the external environment. In time the mechanical properties of the cellulosic material are weakened which manifests itself with bulging of the package-namely deformation of the generally planar surfaces towards having a rounded form.

In the third example, it will be appreciated that the product to be packaged (such as one that is prone to spoilage) may be substantially dry, partly wet, or otherwise, and may be provided at any temperature. For example, some frozen products are provided packaged in laminated cellulosic material such as laminated cardboard packaging, one example of which is ice cream. Variations in storage temperature of such frozen products, such as during transport, can lead to moisture in the packaging material undergoing a freeze/thaw action which in turn can rapidly degrade the structure of the cellulosic material relied on for the packaging's structure.

Conventional moisture barrier materials such as polyethylene, polyacrylates, or waxes provide a moisture resistive layer provided by a matrix of those hydrophobic materials. The strength of that barrier will generally be proportional to the thickness of the layer and the hydrophobicity of the matrix material. Once the layer is penetrated, or if the layer does not otherwise fully cover the material, then the material will be exposed to moisture. Where the material is capable of wicking moisture, such a weakness in the layer will inevitably lead to the ingress of moisture. While that technology is well understood and numerous polymers and waxes have been used, those coated materials are typically not biodegradable or recyclable.

The present invention differs from other previous approaches to modifying the water permeability of a material. In each case the previous approaches seek to create a barrier layer at the surface of the paper, typically by the technique of dispersion coating which is inherently prone to imperfections imposed by the irregular surface profile of paper on a microscopic scale. For instance, WO2021224881 discloses the application of a glyceride and/or a fatty acid salt to a cellulosic/polymeric material to make it hydrophobic and/or lipophilic. Likewise, WO2021105231 discloses the use of a composite material having multiple layers of water impermeable polymers, most of which are non-biodegradable and would typically mean that the coated product is neither recyclable nor biodegradable. Similarly, the technology in WO2021105231 uses (meth)acrylate polymers to reduce water permeability.

Without wishing to be bound by theory, it is believed that the application of the hygroscopic salt; phyllosilicate mineral; and/or cellulosic particle to the material in the present invention provides a function that is different to the resistive function attempted by conventional moisture barrier materials (such as polyethylene, polyacrylates, or waxes). Again without wishing to be bound by theory, conceptually it is believed that the present invention provides a capacitive (i.e, functions as a capacitor) function which importantly is provided across the whole material (since the hygroscopic salt; phyllosilicate mineral; and/or cellulosic particle is believed to be adsorbed to the surface of/or entrained within, and in intimate contact with, the material) rather than as a layer separate to the material. The hygroscopic salt; phyllosilicate mineral; and/or cellulosic particle has a capacity (or threshold) to interact with moisture beyond which the hygroscopic salt; phyllosilicate mineral; and/or cellulosic particle will effectively become saturated and no longer inhibit moisture vapour transmission to or across the material. Below such a capacity (or threshold) the moisture vapour transmission will be inhibited and it is believed that adding more hygroscopic salt; phyllosilicate mineral; and/or cellulosic particle will lead to greater inhibition of moisture vapour transmission.

The present invention may more broadly relate to a material including a matrix of fibres, the matrix having at least one of the following:
a) a first substance having water adsorption qualities, the substance being adsorbed to the surface of the fibres, and
b) a second substance that inhibits moisture transmission, and
c) a dispersive substance which aids in dispersing the first substance within the fibre matrix.

In some embodiments the second substance may inhibit moisture transmission, and aid in dispersing the first substance within the fibre matrix.

The present invention may relate to a method of applying the first substance and/or the second substance and/or the dispersive substant to the material.

Further aspects of the technology, which should be considered in all its novel aspects, will become apparent to those skilled in the art upon reading of the following description which provides at least one example of a practical application of the technology.

### BRIEF DESCRIPTION OF THE DRAWINGS

One or more embodiments of the technology will be described below by way of example only, and without intending to be limiting, with reference to the following drawings, in which:

FIG. 1 shows an example of the water holding capacity per coating weight of compositions according to the invention;

FIG. 2 shows an example of the water holding efficiency of coatings with microfibrillated cellulose, and both microfibrillated cellulose and nanocrystalline cellulose, with varying calcium chloride content.

### DETAILED DESCRIPTION OF THE INVENTION

### Hygroscopic Salt

The present invention is predicated in part on the realisation that the properties (such as moisture vapor transmission rate) of the matrix of fibres may be modulated by the presence of a hygroscopic salt adsorbed to the surface of the fibres. As used herein the term “hygroscopic” refers to the ability of the hygroscopic salt to absorb water from air. Such a hygroscopic salt may be applied to the surface of the fibres in a carrier, such as an aqueous carrier, such as in water. As such, the hygroscopic salt is water soluble. After application of the salt as a solution in a carrier, the subsequent removal of the carrier will leave behind the hygroscopic salt. Such a salt may be provided as a hydrate, although it is believed that a form of the hygroscopic salt that is in less than a fully hydrated state is preferred, such as a partially hydrated form, or an anhydrous form.

It will be appreciated that different salts are hygroscopic to different degrees. The degree of hygroscopicity of the hygroscopic salt may be considered to be a function of the cation and the anion. Preferred cations are calcium, magnesium, aluminium, potassium, sodium, zinc, and lithium. Preferred anions are chloride, sulphate, carbonate, and nitrate. All combinations of these cations and anions that are hygroscopic and water soluble are contemplated for use in the present invention.

It will be appreciated that different salts are water soluble to different degrees. The degree of water solubility of the hygroscopic salt may be considered to be a function of the cation and the anion. Preferred cations are calcium, magnesium, aluminium, potassium, sodium, zinc, and lithium. Preferred anions are chloride, sulphate, carbonate, and nitrate. All combinations of these cations and anions that are hygroscopic and water soluble are contemplated for use in the present invention.

Properties of preferred hygroscopic water soluble salts of the present invention are provided in the table below:

| | | | Adsorption | |
|---|---|---|---|---|
| | | Solubility | capacity | |
| | Hygroscopicity | (g of salt/ | of 100 g of | Affinity |
| | (g of moisture | 100 g of | saturated | for |
| | per g of salt) | water) | solution | cellulose |
| calcium chloride | 0.8 | 74.5 | 59.6 | *** |
| magnesium | 0.6 | 54.3 | 32.58 | *** |
| chloride | | | | |
| aluminium | 0.5 | 44.5 | 22.25 | *** |
| sulphate | | | | |
| calcium nitrate | 0.4 | 121.2 | 48.48 | *** |
| potassium nitrate | 0.4 | 13.3 | 5.32 | * |
| potassium | 0.3 | 112 | 33.6 | * |
| carbonate | | | | |
| sodium nitrate | 0.2 | 91.2 | 18.24 | * |
| sodium chloride | 0.1 | 36 | 3.6 | * |

The table also indicates relative affinity for cellulose—with those noted as *** showing the highest affinity for cellulose (which is a preferred characteristic) and those noted as * showing a lower affinity for cellulose (less preferred).

Some preferred salts of the invention are calcium chloride, magnesium chloride lithium chloride, zinc chloride, and aluminium chloride. The most preferred salts of the invention are calcium chloride, magnesium chloride, aluminium sulphate, and calcium nitrate. Of these, calcium chloride is considered to be the most preferred.

The invention contemplates the use of either single hygroscopic water soluble salts, or combinations of different hygroscopic water soluble salts.

Calcium chloride is deliquescent (becomes liquid after adsorbing high amounts of moisture). In situations of exposure to environments with moderate humidity, calcium chloride can absorb excess moisture, potentially helping to keep the material (such as paper fibres) dry and strong. In particular, by reducing the moisture content of the surrounding air, calcium chloride can prevent the paper fibres from swelling, thereby maintaining their mechanical integrity.

However, in environments of prolonged exposure to high humidity calcium chloride can become liquid. Once liquid the reverse effect will generally apply to the paper material. In such embodiments, it may be preferable to use non-deliquescent hygroscopic salts such as potassium carbonate and sodium carbonate.

Without wishing to be bound by theory it is believed that the present invention is particularly effective in reducing moisture transmission across a material due to the following factors shared by these particular hygroscopic salts:
i) the salts are soluble in carriers, such as aqueous solvents (such as the preferred carrier water) making them easy to use commercially and easier to recycle and/or biodegrade;
ii) the salts are hygroscopic, and in some cases are deliquescent salts. It is believed that the salts form extensive ionic layers adsorbed to the fibres;
iii) the salts disperse efficiently across the material (such as the preferred cellulosic material);
iv) several of the hygroscopic salts (such as calcium chloride and magnesium chloride) are generally regarded as safe (GRAS) for use in food packaging in particular.

In some embodiments the hygroscopic salt is lithium chloride. Lithium chloride is highly soluble in water and is hygroscopic. Lithium chloride has an affinity for cellulose surfaces which makes it suitable for cellulose modification processes. As a monovalent cation, lithium (Li⁺) has a relatively small ionic radius, and it does not typically form extensive ionic layers of adsorbed water on cellulose fibres compared to divalent or trivalent cations like calcium (Ca²⁺) or aluminium (Al³⁺).

In some embodiments the hygroscopic salt is zinc chloride. Zinc chloride is soluble in water and is hygroscopic. Zinc chloride can be used in the modification of cellulose fibres due to its ability to form complexes with cellulose, thereby enhancing its properties such as strength and moisture resistance. Zinc chloride can be used in the production of food packaging materials such as films, coatings, and liners.

In some embodiments the hygroscopic salt is aluminium chloride. Aluminium chloride is soluble in water and is hygroscopic. It can modify cellulose surfaces and enhance its properties.

In some embodiments the hygroscopic salt is calcium chloride. Calcium chloride is soluble in water and is hygroscopic. Calcium chloride is classified as Generally Recognized as Safe (GRAS) by the FDA when used in accordance with good manufacturing practices (GMP) and within specified limits. Calcium chloride is approved for direct addition to food and is considered safe for use in various food products.

### Phyllosilicates

The phyllosilicate that may be used in the present invention is a sheet silicate mineral, or a combination of different phyllosilicates. Examples of suitable phyllosilicates are a serpentine, a clay, or a mica mineral. Preferably the phyllosilicate is a clay or a mica mineral. Examples of suitable clays include a halloysite, kaolinite (kaolin), a pyrophyllite, talc, illite, smectite (such as a montmorillonite mineral), chlorite, vermiculite, sepiolite, or a palygorskite (attapulgite) mineral. Examples of suitable mica minerals include a biotite, fuchsite, muscovite, phlogopite, lepidolite, margarite, or a glauconite mineral. Examples of suitable serpentine minerals are an antigorite, chrysotile, or a lizardite mineral. Preferably the phyllosilicate is selected from a kaolinite (such as red kalonite, such as kaolin), talc, illite (such as red illite, or green French clay), or a bentonite (such as red bentonite). Bentonite is particularly useful in the present invention since its availability is widespread, it is relatively inexpensive, and it performs well.

Without wishing to be bound by theory, it is believed that the phyllosilicate may be included (such as entrained) within the matrix (such as within pores within the matrix). It is believed that the phyllosilicates are likely to form agglomerations in combination with the hygroscopic water soluble salt (such as calcium chloride) acting as a flocculation agent. This working theory is based on the observation that there is an significant increase in the viscosity of a composition of the hygroscopic water soluble salt and the phyllosilicate in solution, compared with a solution of the hygroscopic water soluble salt alone. It is theorised that the phyllosilicates are an agent of agglomeration.

### Cellulosic Particle

The cellulosic particle may be cellulose or a modified cellulose (such as cellulose acetate) and may contain a mixture of cellulose/modified cellulose with other material(s). The cellulosic particle may be derived from any source of material including both naturally occurring and synthetic/semi-synthetic sources (including synthetic biology sources).

The cellulosic particle is preferably selected from micro-fibrillated cellulose, microcrystalline cellulose, and nano-structured cellulose, and combinations thereof. These forms of cellulose may be formed by treating cellulose in a range of different ways, including by applying shear, reactive extrusion, enzyme mediated hydrolysis, mechanical grinding, ultrasonication, steam explosion, and acid hydrolysis.

The cellulosic particle can be entrained within the matrix. This ability will generally be related to the size of the pores that may be found in the matrix, such that the size of the cellulosic particle will be smaller than the size of the pores. For example, the size of the cellulosic particle may be less than 0.1 μm, or from 0.1 to 1 μm, or from 0.1 to 20 μm, or from 0.01 to 200 μm, or from 0.1 to 400 μm. While the cellulosic particle of the invention is described with reference that it “can be entrained within the matrix”, it may equally be the case that the cellulosic particle of the invention is actually entrained within the matrix where the cellulosic particle and the matrix have been placed in contact with eachother.

For illustrative purposes only, it is worthwhile discussing the entrainment of cellulosic particles within the matrix of fibres provided in office paper. Such a matrix may be considered to provide pores as the interstitial space between the fibres in the matrix. The average pore size in a sheet of office paper typically ranges from about 10 to 100 micrometres (μm) in diameter. This range can vary depending on the specific type of office paper, its manufacturing process, and the intended use. In some embodiments it may be beneficial to use a flocculating agent where cellulosic particles having a size of less than 1 μm are used, so that the cellulosic particles are retained within the pores. One such flocculating agent that may be used is calcium cations. For example, micro-fibrillated cellulose particles (and some phyllosilicates such as bentonite) and have net negative surface charges. When calcium ions are brought into contact with such a charged surface, particularly when both are dispersed in a carrier, they are attracted to the negatively charged surfaces of these particles causing them to flocculate.

Without wishing to be bound by theory, it is believed that the cellulosic particle may be included (such as entrained) within the matrix of the material (such as within pores within the material) and/or assist with the dispersion of the hygroscopic salt where the components are used in combination. In particular, it is believed that the hygroscopic salt can also adsorb to the surface of the cellulosic particle.

### Material (Substrate)

The material (which may otherwise be referred to as the substrate), such as the packaging material, fabric, or building material, includes a matrix of fibres, and may be in the form of a membrane, panel, hydrogel, paste, granule, or pellet, for example. The fibres of the material will typically be formed of polymeric material—the polymer being a biological polymer or a synthetic polymer although blends of biological and synthetic polymers are also contemplated.

In general, the matrix of fibres of the material will provide a porous structure which can adsorb a hygroscopic salt and/or retain the phyllosilicate or cellulosic particle of the invention. Examples of such structures are all forms of paper, fabric/cloth (e.g. woven, knitted, non-woven, felted, laminated and spun), and porous construction/architectural materials (e.g. plasterboard, ceiling tiles, foam insulation, panels, plaster).

By way of example only, there are many different types of paper available and suitable for different types of applications. The properties of the paper may be targeted in the paper making process to satisfy market requirements/demand. For a barrier coating/resistive layer a paper with low porosity and high smoothness is desired primarily so that a dispersion coating of a barrier material will bond to the surface to maximise its barrier properties. While the use of such paper in the current invention is contemplated, it is preferred to use paper that does not have a low porosity. The present inventors have discovered that paper suppliers (such as Mondi, Billerud et al.) that are asked to supply higher porosity papers, generally having a reduced smoothness, have been surprised to be asked to supply such paper. This support the non-obvious nature of such material for use in the present invention. In particular, the inventors' request contradicts their current understanding, and commercial availability of such paper is much reduced compared with normal barrier material paper. Preferably the present invention uses unsized, highly porous paper. It is believed that such paper provides enhanced adsorption of the hygroscopic salt, and entrainment of phyllosilicate material and/or cellulosic particle where used. In some embodiments the (paper) material is uncoated highly porous kraft cellulose-fibre material.

Where the fibres are formed of a polymeric material, preferably the polymer is biodegradable. More preferably the polymer is compostable under both industrial and non-industrial conditions. One recognised non-industrial composting standard is ISO 14855-1 (2012). An example of such a biodegradable material is one that may degrade in home composting conditions where temperatures typically do not attain the temperatures found in industrial composting settings. Preferably the biodegradable polymer of the invention is configured to undergo substantial biodegradation within 12 months of being exposed to non-industrial composting conditions. Preferably the biodegradable composition of the invention is configured to fully biodegrade within 24 months of being exposed to non-industrial composting conditions.

The polymer may be selected from:
an aliphatic polyester such as: polyglycolide/poly(glycolic acid) (PGA), polycaprolactone (PCL), polydioxanone (PDO), polylactic acid (PLA) (including poly(L-lactic acid), poly(D-lactic acid), and poly(DL-lactic acid)), poly(lactic-co-glycolic acid) (PLGA), poly(trimethylene carbonate) (PTMC), poly(butylene succinate-co-butylene adipate) (PBSA), poly(alkyl succinates), including: poly(ethylene succinate) (PES), (poly(propylene succinate) (PPS), poly(butylene succinate) (PBS); polyhydroxyalkanoates (PHA), including polyhydroxybutyrate (PHB), polyhydroxyvalerate (PHV), polyhydroxyhexanoate (PHH), polyhydroxyoctanoate (PHO), polyhydroxydecanoate (PHD), polyhydroxy-5-phenylvalerate (PHPV), poly(3-hydroxybutyrate-co-3-hydroxyvalerate) (PHBV);
an aromatic polyester such as: poly(butylene adipate-co-terephthalate) (PBAT);
a polyamide such as BAK 1095 and BAK 2195 (based on caprolactam, butanediol, and adipic acid);
a polyurethane that will typically include a biodegradable portion consisting of a polyester (such as PCL, PLA, and PGA);
an agro-polymer (such as such as silk, wool, collagen);
a polysaccharide (such as starch, hemicellulose, cellulose, chitin, chitosan, alginic acid, cellophane, pectin, pullulan, or modified forms thereof, for example cellulose acetate);
a polypeptide (such as gelatin, wheat gluten, casein, whey protein);
a vinyl alcohol such as polyvinylalcohol or vinyl alcohol precursor such as poly(vinyl acetate).

Without wishing to be bound by theory, it is believed that materials having a degree of ionic attraction to the hygroscopic salt of the invention are preferred. In many cases, such materials will include functional groups that provide a dipole moment capable of attracting and retaining the cation of the hygroscopic salt. It is believed that the ability to attract and retain the cation of the hygroscopic salt enables the hygroscopic salt to be well dispersed across the material and in turn attract and retain moisture that comes into the environment of the material. By attracting and retaining the moisture the present invention is able to decrease the moisture transmission rate across the material.

In preferred embodiments, the material is paper. The paper may be composed of blends of natural polymers, such as cellulose, lignin and hemi-cellulose.

Advantageously, the use of cellulose (or a modified form of cellulose) as part of the material of the invention has been shown to provide the following advantages:
it attracts and retains the cation of the hygroscopic salt of the invention-such as the calcium cation of the calcium chloride salt;
it is used widely in packaging;
it is biodegradable, and is home compostable.

In some embodiments the substate is a cellulose material such as paper, cardboard, cotton, jute, hemp, sisal, or wood. In some embodiments the substate is a cotton membrane, cellulose membrane, or lignin-based membrane. In some embodiments the substate is paper fibres which are comprised of fibrils, microfibrils which in turn contain cellulose polymers. The cellulose containing fibre may be cellulose fibres extracted from a wood source that are used to make an end product such as paper, paperboard or cardboard. In some embodiments, the cellulose fibres may be combined to form a pulp and are then processed into the desired end product with the desired weight, i.e., grams per square metre (gsm). In some embodiments, when the substate is a paper, the paper weight may be between 50 grams per square meter to 300 grams per square meter, such as about 125 gsm. In some embodiments the material may have a heavier weight than paper-such as heavyweight paperboard which may have a weight of 400 to 600 gsm. Such material is commonly used for more robust packaging applications where additional strength and durability are required, such as rigid boxes, high-end product packaging, and displays. Beyond 600 gsm, the material is often referred to as “chipboard” or “greyboard,” and it is primarily used for applications where stiffness and rigidity are essential, such as book covers, binders, and rigid packaging boxes. All of these forms/weights of products are contemplated for use as the material (material) in the present invention.

In some embodiments the material is a starch-based material, including certain types of packaging or starch-based films, which may adsorb salts (such as calcium chloride) through hydrogen bonding, leading to increased water adsorbency.

In some embodiments the material is a hydrogel. Hydrogels are known for their ability to absorb and retain water. The hydrogel may be formed from polymers such as polyvinyl alcohol (PVA), polyacrylamide, or polysaccharides, which can form hydrogen bonds with salts (such as calcium chloride) resulting in increased water adsorbency.

In some embodiments, the material is chitosan, derived from chitin, which contains amino and hydroxyl groups that can form hydrogen bonds with salts (such as calcium chloride), resulting in increased water adsorbency. Chitosan is used in various applications, including as a water treatment agent.

In some embodiments, the material is silica gel and other silica-based materials which may adsorb salts (such as calcium chloride) through hydrogen bonding, leading to increased water adsorbency. Silica surfaces have hydroxyl groups that can interact with salts such as calcium chloride ions. In some embodiments the substate is sintered glass.

In some embodiments, the material is a clay or an aluminosilicate. The aluminosilicate may be a zeolite. Clays and zeolites have hydrophilic surfaces, which can adsorb salts such as calcium chloride ions through hydrogen bonding, resulting in increased water adsorbency. Where the material is a phyllosilicate mineral, the phyllosilicate mineral will be provided with a hygroscopic salt and/or a cellulosic particle of the invention.

In some embodiments the material is carbon. In some embodiments the carbon is activated carbon that is preferably functionalised with functionality (such as carboxyl (—COOH), hydroxyl (—OH), or carbonyl (—C═O) groups) that promotes absorbency of the hygroscopic salt of the invention.

In some embodiments the density of the substate may be approximately 800-1400 kg/m³; such as approximately 900-1300 kg/m³; such as approximately 1000-1300 kg/m³.

Preferably the material is provided in a substantially planar form, such as in the form of a sheet and/or membrane-such as paper or card/cardboard. In some embodiments the substate in a membrane form may between about 1 to about 500 gsm; such as from 1 to 200 gsm, such as from 50 to 300 gsm, such as from 75 to 150 gsm, such as about 125 gsm.

In some embodiments the barrier properties of the substate in a membrane form are such that water vapour transmission through the polymeric layer is less than 50 gsm per day at 25 degrees C and 75% relative humidity.

The barrier properties of the material may be enhanced through the additional use of a conventional dispersion coating, such as a coating of a polymeric material, such as a wax or polyhydroxyalkanoate material.

### Carrier

The present invention may make use of one or more carriers to disperse one or more of the hygroscopic salt, the phyllosilicate mineral, and/or the cellulosic particle. The carrier will preferably be an aqueous carrier, such as water, and will disperse (such as dissolve) the hygroscopic salt, the phyllosilicate mineral, and/or the cellulosic particle so as to form a dispersion in the aqueous carrier (such as solution) that is capable of being applied to the material.

The properties of the carrier, such as pH and temperature, may be modified to assist with dispersing the hygroscopic salt, the phyllosilicate mineral, and/or the cellulosic particle.

The physical and/or chemical nature of the carrier (such as temperature; pH; use of surfactants, dispersing agents, and/or flocculants) may be adjusted to modulate the solubility or other properties of the hygroscopic salt, the phyllosilicate mineral, and/or the cellulosic particle being carried therein. For instance, it will be appreciated that the size of the cellulosic particles may lead to agglomeration which may or may not be desired. By adjusting the physical and/or chemical nature of the carrier the desired dispersion of the cellulosic

### Additional Layer(s)

In some embodiments the material of the invention (such as the packaging material) may be provided with one or more additional layers of material. Such additional layer(s) of material may be provided to the material before or after the hygroscopic salt, the phyllosilicate mineral, and/or the cellulosic particle is provided on the material.

An additional layer may be provided as a membrane such that:
The membrane provides barrier properties such that water vapour transmission through the additional layer is less than 300 gsm per day at 25 degrees C and 75% relative humidity. It is to be appreciated that lesser water vapour transmission may be desirable and water vapour transmission may be less than any of 250, 200, 150, 100, 50 or 40 gsm per day at 25 degrees C and 75% relative humidity. Without being limiting, it is generally true that the lesser the water vapour transmission rate at 25 degrees C and 75% relative humidity, the greater the barrier properties of the material (such as a packaging material or building material) and the greater the range of water sensitive produce that can be packaged using the packaging material; and/or
The membrane provides oxygen transmission barrier properties, such that oxygen transmission through the second layer is less than 400 cm³/m³ per day at 1 atm oxygen, 25 degrees C and 75% relative humidity. It is to be appreciated that lesser oxygen transmission may be desirable and oxygen vapour transmission may be less than any of 300, 250, 200, 150, 100 or 50 cm³/m³ per day at 1 atm oxygen, 25 degrees C and 75% relative humidity. Without being limiting, it is generally true that the lesser the oxygen transmission rate at 1 atm oxygen, 25 degrees C and 75% relative humidity, the greater the barrier properties of the packaging material and the greater the range of oxygen sensitive produce that can be packaged using the packaging material.

In some embodiments, the or each additional layer may be independently selected from being from 1 to 500 μm in thickness, such as from 1 to 200 μm in thickness, such as from 1 to 50 μm in thickness, such as up to 30 μm in thickness. It is to be appreciated that a range of thicknesses may be suitable, depending on the application, such as the packaging or building application, and the or each additional layer may be about 10 to about 25 μm in thickness or may be about 15 to about 20 μm in thickness.

In some embodiments, the or each additional layer may be formed of polymeric material—the polymer being a biological polymer or a synthetic polymer although blends of biological and synthetic polymers are also contemplated.

Preferably the polymer is biodegradable. More preferably the polymer is compostable under both industrial and non-industrial conditions. One recognised non-industrial composting standard is ISO 14855-1 (2012). An example of such a biodegradable material is one that may degrade in home composting conditions where temperatures typically do not attain the temperatures found in industrial composting settings. Preferably the biodegradable polymer of the invention is configured to undergo substantial biodegradation within 12 months of being exposed to non-industrial composting conditions. Preferably the biodegradable composition of the invention is configured to fully biodegrade within 24 months of being exposed to non-industrial composting conditions.

The polymer may be selected from:
an aliphatic polyester such as: polyglycolide/poly(glycolic acid) (PGA), polycaprolactone (PCL), polydioxanone (PDO), polylactic acid (PLA) (including poly(L-lactic acid), poly(D-lactic acid), and poly(DL-lactic acid)), poly(lactic-co-glycolic acid) (PLGA), poly(trimethylene carbonate) (PTMC), poly(butylene succinate-co-butylene adipate) (PBSA), poly(alkyl succinates), including: poly(ethylene succinate) (PES), (poly(propylene succinate) (PPS), poly(butylene succinate) (PBS); polyhydroxyalkanoates (PHA), including polyhydroxybutyrate (PHB), polyhydroxyvalerate (PHV), polyhydroxyhexanoate (PHH), polyhydroxyoctanoate (PHO), polyhydroxydecanoate (PHD), polyhydroxy-5-phenylvalerate (PHPV), poly(3-hydroxybutyrate-co-3-hydroxyvalerate) (PHBV);
an aromatic polyester such as: poly(butylene adipate-co-terephthalate) (PBAT);
a polyamide such as BAK 1095 and BAK 2195 (based on caprolactam, butanediol, and adipic acid);
a polyurethane that will typically include a biodegradable portion consisting of a polyester (such as PCL, PLA, and PGA);
an agro-polymer (such as such as silk, wool, collagen);
a polysaccharide (such as starch, hemicellulose, cellulose, chitin, chitosan, alginic acid, cellophane, pectin, pullulan, or modified forms thereof, for example cellulose acetate);
a polypeptide (such as gelatin, wheat gluten, casein, whey protein);
a vinyl alcohol such as polyvinylalcohol or vinyl alcohol precursor such as poly(vinyl acetate).

In some embodiments the barrier properties of at least one additional layer is such that water vapour transmission through the additional layer is less than 50 gsm per day at 25 degrees C and 75% relative humidity.

### Method of Application

The hygroscopic salt, phyllosilicate mineral, and/or cellulosic particle (where used) may be applied separately, or together in any combination possible. Generally each of the hygroscopic salt, phyllosilicate mineral, and/or cellulosic particle (where used) will be dispersed (such as dissolved) in one or more carriers (such as an aqueous carrier, such as water) and the dispersion (such as solution) will be applied to the material. Most existing technologies for applying surface treatments to paper are suitable to apply the compositions of the present invention. These include, size presses, short and long dwell coaters, slot coaters, spray coaters, etc.

The hygroscopic salt of the present invention is provided as a salt of calcium, lithium, zinc, or aluminium. In each case, but especially so for calcium, zinc, and aluminium, it can be difficult to optimally apply the salt to the material especially when the material is cellulose. Without wishing to be bound by theory, and by way of example, it is believed to be especially challenging to apply calcium chloride to a cellulose paper because the hydroxyl groups have a strong affinity to the cation, which coincidentally is why some of the materials of the invention have been shown to be so effective in decreasing the transmission of moisture through the material.

The present invention can overcome any such challenge particularly when the method of application makes use of a pressure gradient to encourage the chloride/carrier onto/into the material. In some examples, such a pressure gradient may be provided by a pressure pulse which could be thought of as a positive pressure gradient. The pressure pulse may be provided by a blade or pressure roll coater (such as a size press) which can form a pressure pulse as the paper passes through the nip between them and a backing roll. Another mechanism for overcoming any such challenge is to use a negative pressure gradient such as may be provided by a vacuum to draw the chloride/carrier into the material.

The same, or a different, method of application may be repeated for successive applications of the hygroscopic salt, phyllosilicate mineral, and/or cellulosic particle. In some preferred embodiments, each of the hygroscopic salt, phyllosilicate mineral, and cellulosic particle are applied as a mixture in one coating operation.

The quantity of the hygroscopic salt (where used) that may be applied to the material may depend on the intended purpose or application of the material so formed. It may be convenient to refer to the amount of the hygroscopic salt (where used) that is applied with reference to its dry weight per unit surface area of the material. For instance, from 1 to 500 gsm may be applied to the material, such as from 1 to 200 gsm, such as from 5 to 100 gsm. The quantity may be applied in a single application step, or a plurality of application steps. The or each application step may apply from 1 to 100 gsm to the material, such as from 1 to 50 gsm, such as from 1 to 25 gsm, such as from 5 to 25 gsm, such as from 10 to 25 gsm.

The quantity of the phyllosilicate mineral (where used) that may be applied to the material may depend on the intended purpose or application of the material so formed. It may be convenient to refer to the amount of the phyllosilicate mineral (where used) that is applied with reference to its dry weight per unit surface area of the material. For instance, from 1 to 500 gsm may be applied to the material, such as from 1 to 200 gsm, such as from 1 to 100 gsm, such as from 5 to 100 gsm. The quantity may be applied in a single application step, or a plurality of application steps. The or each application step may apply from 1 to 100 gsm to the material, such as from 1 to 50 gsm, such as from 1 to 25 gsm, such as from 5 to 25 gsm, such as from 10 to 25 gsm.

The quantity of the cellulosic particle (where used) that may be applied to the material may depend on the intended purpose or application of the material so formed. It may be convenient to refer to the amount of the cellulosic particle (where used)) that is applied with reference to its dry weight per unit surface area of the material. For instance, from 1 to 500 gsm may be applied to the material, such as from 1 to 200 gsm, such as from 1 to 100 gsm, such as from 5 to 100 gsm. The quantity may be applied in a single application step, or a plurality of application steps. The or each application step may apply from 1 to 100 gsm to the material, such as from 1 to 50 gsm, such as from 1 to 25 gsm, such as from 5 to 25 gsm, such as from 10 to 25 gsm.

An application rate of from 1 to 25 gsm, such as from 5 to 25 gsm, such as from 10 to 25 gsm per application step is believed to be particularly beneficial to materials such as cellulose, or modified cellulose, such as paper, card or cardboard having a weight of about 125 gsm.

Without wishing to be bound by theory, it is believed that the hygroscopic salt is adsorbed to the surface of the fibres of the matrix of the material. As referred to herein, “adsorbed” refers to the cation bonding to the cellulose. Without wishing to be bound by theory, it is believed that the phyllosilicate mineral, and/or cellulosic particle are retained by a combination of filtration and the flocculating effect of the cation of the hygroscopic salt-which effect is referred to herein as being “entrained” within the matrix. For instance, the cellulosic particles and/or phyllosilicates may be considered to be of the same charge as the matrix of fibres wherein the fibres are cellulosic. In such a case, the presence of the hygroscopic salt, such as calcium chloride (particularly the calcium cations) will provide somewhat of a bridge between the fibres and the cellulosic particles and/or phyllosilicates. It is believed that this mechanism of adsorbency/adherency leads to maximal dispersal of the hygroscopic salt (in particular) across the material and hence maximising pickup of the active ingredients and the consequent maximal reduction in moisture transmission across the material.

As opposed to adsorbency, absorbency involves the substance being drawn into and held within the internal structure of the material such as within pores of the matrix. Absorbance is likely the predominant mechanism for retaining the particulate components of the treatment, particularly in an agglomerated form.

### Applications & Advantages

The packaging material of the present invention may be used in a myriad of packaging applications where the packaged product or the package itself is susceptible to damage from moisture and/or oxygen.

### Examples of Such Packaged Products Include

Electronics and Electronic Components
Pharmaceuticals
Foodstuffs, such as powdered milk, coffee, or powdered supplements
Certain textiles and fabrics, especially those prone to mildew or mould growth
Certain types of paper, such as copy paper

### Examples of Food Packaging Applications Include

Flexible stand-up pouches that are re-sealable and come in a range of sizes;
Rigid packaging such as takeaway coffee cups, containers of chilled or frozen dairy products, and bowls and trays manufactured through pressing or vacuum forming; and
Rigid packaging such as 3D pulp containers manufactured through traditional pulping methods with thermoformed polymer layer.
Paperboard packaging used for liquid foods which can be weakened by prolonged exposure to moisture during distribution and use.
Secondary packaging, such as corrugated boxes, which can be weakened by prolonged exposure to cyclic humidity during distribution and fail to protect their contents form mechanical damage.

The building material of the present invention may be used in a myriad of building applications where it is desirable to reduce the transmission of moisture and/or oxygen from one side of the material to the other side of the material. For instance, the material may be used to control humidity within buildings by installing wallboards and/or ceiling tiles treated with the hygroscopic salt, phyllosilicate mineral, and/or cellulosic particle. The addition of one or more of these components could enhance the wallboard's ability to absorb moisture from the surrounding environment. This property might be advantageous in certain applications, such as controlling humidity in indoor spaces during periods of cyclic diurnal humidity . . .

The building material of the present invention may also be used as a sink/source of moisture such that it absorbs moisture under humid conditions and releases moisture under dry conditions so as to modulate the humidity in an environment.

### EXAMPLES

### Controls: Kraft Cellulose-Fibre Material—Negative Control; and Kraft Cellulose-Fibre Material Coated with a Polymeric Layer of PHA (25 gsm)—Positive Control

Uncoated highly porous kraft cellulose-fibre material (125 gram per square meter) was measured to have a water vapour transmission rate (WVTR) of 3000 g/m²/24 hr (measured at 25 degrees Celsius and at 75% relative humidity). For this material, this WVTR represents a negative control.

For a positive control, to be used as a reference for how the product of the present invention provides a useful alternative and believed to overcome some problems associated with using a barrier layer, a polymeric coating of polyhydroxyalkanoates (PHA) (25 gram per square meter, 20 micron) was applied directly to a sheet of highly porous kraft cellulose-fibre material (125 gram per square meter) with a compostable adhesive by air atomizing spray nozzle. The adhesive used was sourced from a compostable laminating adhesive sold by Scitech Adhesive Systems as ST6093G HS.

It was found with this positive control provided an average water vapour transmission rate of 115 g/m²/24 hr (measured at 25 degrees Celsius and at 75% relative humidity). The oxygen transmission rate of this packaging material was also measured and the average was calculated as 400 cm³/m²/24 hr.

### Example 1—Kraft Cellulose-Fibre Material Coated with Bentonite Clay (11.67 gsm), Calcium Chloride (15.83 gsm), and Microfibrillated Cellulose and Bentonite Clay (4.31 gsm)

In this example, a sheet of highly porous kraft cellulose-fibre material (125 gram per square meter) was spray coated directly by air atomizing spray nozzle with a dispersion of bentonite clay which was then dried to provide on a dry weight basis a 11.67 grams per square meter coating of bentonite clay. A solution of calcium chloride was then spray coated directly by air atomizing spray nozzle onto the bentonite clay coated material and then dried to provide on a dry weight basis a 15.83 grams per square meter coating of calcium chloride. A dispersion of 6 wt % bentonite clay and 1.5 wt % microfibrillated cellulose was then spray coated directly by air atomizing spray nozzle onto the bentonite clay and calcium chloride coated material and then dried to provide on a dry weight basis a 4.31 grams per square meter coating of bentonite clay and microfibrillated cellulose.

It was found with this example that the average water vapour transmission rate was 1223 g/m²/day (measured at 25 degrees Celsius and at 75% relative humidity), a reduction from a water vapour transmission rate of 3000 g/m²/24 hr (measured at 25 degrees Celsius and at 75% relative humidity) for the uncoated highly porous kraft cellulose-fibre material (125 gram per square meter).

### Example 2—Kraft Cellulose-Fibre Material Coated with Bentonite Clay (11.67 gsm)

In this example, a sheet of highly porous kraft cellulose-fibre material (125 gram per square meter) was spray coated directly by air atomizing spray nozzle with a dispersion of bentonite clay which was then dried to provide on a dry weight basis a 11.67 grams per square meter coating of bentonite clay.

It was found with this example that the average water vapour transmission rate was 344 g/m²/day (measured at 25 degrees Celsius and at 75% relative humidity), a significant reduction from a water vapour transmission rate of 3000 g/m²/24 hr (measured at 25 degrees Celsius and at 75% relative humidity) for the uncoated highly porous kraft cellulose-fibre material (125 gram per square meter).

### Example 3—Kraft Cellulose-Fibre Material Coated with Microfibrillated Cellulose (6.93 gsm)

In this example, a sheet of highly porous kraft cellulose-fibre material (125 gram per square meter) was spray coated directly by air atomizing spray nozzle with a dispersion of microfibrillated cellulose which was then dried (the process of spray coating and drying completed three more times) to provide on a dry weight basis a 6.93 grams per square meter coating of microfibrillated cellulose.

It was found with this example that the average water vapour transmission rate was 681 g/m²/day (measured at 25 degrees Celsius and at 75% relative humidity), a significant reduction from a water vapour transmission rate of 3000 g/m²/24 hr (measured at 25 degrees Celsius and at 75% relative humidity) for the uncoated highly porous kraft cellulose-fibre material (125 gram per square meter).

### Example 4—Kraft Cellulose-Fibre Material Coated with Microfibrillated Cellulose and Bentonite Clay (12.93 gsm)

In this example, a sheet of highly porous kraft cellulose-fibre material (125 gram per square meter) was spray coated directly by air atomizing spray nozzle with a dispersion of 1.5 wt % microfibrillated cellulose and 6 wt % bentonite clay and which was then dried to provide on a dry weight basis a 12.93 grams per square meter coating of microfibrillated cellulose and bentonite clay.

It was found with this example that the average water vapour transmission rate was 868 g/m²/day (measured at 25 degrees Celsius and at 75% relative humidity), a significant reduction from a water vapour transmission rate of 3000 g/m²/24 hr (measured at 25 degrees Celsius and at 75% relative humidity) for the uncoated highly porous kraft cellulose-fibre material (125 gram per square meter).

### Example 5—Kraft Cellulose-Fibre Material Coated with Calcium Chloride (15.8 gsm)

In this example a sheet of highly porous kraft cellulose-fibre material (125 gram per square meter) was spray coated directly by air atomizing spray nozzle with a solution of calcium chloride, which was then dried to provide on a dry weight basis a 15.8 grams per square meter coating of calcium chloride. The coating was applied in a 50 wt % solids solution after dissolving in deionized water. It was found with this example that the average water vapour transmission rate was reduced to 217 g/m²/day (measured at 25 degrees Celsius and at 75% relative humidity), a very significant reduction from a water vapour transmission rate of 3000 g/m²/24 hr (measured at 25 degrees Celsius and at 75% relative humidity) for the uncoated highly porous kraft cellulose-fibre material (125 gram per square meter).

### Example 6—Kraft Cellulose-Fibre Material Coated with Calcium Chloride (63.3 gsm)

In this example a sheet of highly porous kraft cellulose-fibre material (125 gram per square meter) was spray coated directly by air atomizing spray nozzle with a solution of calcium chloride, which was then dried to provide on a dry weight basis a 63.3 grams per square meter coating of calcium chloride. The coating was applied in a 50 wt % solids solution after dissolving in deionized water. It was found with this example that the average water vapour transmission rate was reduced to 255 g/m²/day (measured at 25 degrees Celsius and at 75% relative humidity), a very significant reduction from a water vapour transmission rate of 3000 g/m²/24 hr (measured at 25 degrees Celsius and at 75% relative humidity) for the uncoated highly porous kraft cellulose-fibre material (125 gram per square meter). It was interesting to note that a fourfold increase in the dry weight of the calcium chloride over that tested in Example 5 did not lead to any further decrease in the water vapour transmission rate.

### Example 7—Kraft Cellulose-Fibre Material Coated with Bentonite Clay (11.67 gsm), Calcium Chloride (15.83 gsm), Microfibrillated Cellulose and Bentonite Clay (4.31 gsm), and a Polymeric Layer of PHA

In this example, a sheet of highly porous kraft cellulose-fibre material (125 gram per square meter) was spray coated directly by air atomizing spray nozzle with a dispersion of bentonite clay which was then dried to provide on a dry weight basis a 11.67 grams per square meter coating of bentonite clay. A solution of calcium chloride was then spray coated directly by air atomizing spray nozzle onto the bentonite clay coated material and then dried to provide on a dry weight basis a 15.83 grams per square meter coating of calcium chloride. A dispersion of 6 wt % bentonite clay and 1.5 wt % microfibrillated cellulose was then spray coated directly by air atomizing spray nozzle onto the bentonite clay and calcium chloride coated material and then dried to provide on a dry weight basis a 4.31 grams per square meter coating of bentonite clay and microfibrillated cellulose. This example differed from Example 1 in that a polymeric coating of PHA (25 gram per square meter, 20 micron) was then applied directly to the coated material with a compostable adhesive. The adhesive used was sourced from a compostable laminating adhesive sold by Scitech Adhesive Systems as ST6093G HS.

It was found with this example that the average water vapour transmission rate was 62 g/m²/day (measured at 25 degrees Celsius and at 75% relative humidity), a reduction from a water vapour transmission rate of 3000 g/m²/24 hr (measured at 25 degrees Celsius and at 75% relative humidity) for the uncoated highly porous kraft cellulose-fibre material (125 gram per square meter). The oxygen transmission rate of this packaging material was also measured and the average was calculated as 747 cm³/m²/24 hr.

### Example 8—Kraft Cellulose-Fibre Material Coated with Bentonite Clay (11.67 gsm), Calcium Chloride (15.83 gsm), and Microfibrillated Cellulose (4.31 gsm)

In this example, a sheet of highly porous kraft cellulose-fibre material (125 gram per square meter) was spray coated directly by air atomizing spray nozzle with a dispersion of bentonite clay which was then dried to provide on a dry weight basis a 11.67 grams per square meter coating of bentonite clay. A solution of calcium chloride was then spray coated directly by air atomizing spray nozzle onto the bentonite clay coated material and then dried to provide on a dry weight basis a 15.83 grams per square meter coating of calcium chloride. A dispersion of 1.5 wt % microfibrillated cellulose was then spray coated directly by air atomizing spray nozzle onto the bentonite clay and calcium chloride coated material and then dried (the process of spray coating and drying completed one more time) to provide on a dry weight basis a 4.31 grams per square meter coating of microfibrillated cellulose.

### Example 9—Kraft Cellulose-Fibre Material Coated with Calcium Chloride (15.83 gsm), and Microfibrillated Cellulose and Bentonite Clay (12.93 gsm)

In this example, a sheet of highly porous kraft cellulose-fibre material (125 gram per square meter) was spray coated directly by air atomizing spray nozzle with a solution of calcium chloride and then dried to provide on a dry weight basis a 15.83 grams per square meter coating of calcium chloride. A dispersion of 1.5 wt % microfibrillated cellulose and 6 wt % bentonite clay was then spray coated directly by air atomizing spray nozzle onto the calcium chloride coated material and then dried to provide on a dry weight basis a 12.93 grams per square meter coating of microfibrillated cellulose.

### Example 10—Kraft Cellulose-Fibre Material Coated with Calcium Chloride (15.83 gsm), and a Polymeric Layer of Polyhydroxybutyrate (20 gsm)

In this example, a sheet of highly porous kraft cellulose-fibre material (125 gram per square meter) was spray coated directly by air atomizing spray nozzle with a solution of calcium chloride and then dried to provide on a dry weight basis a 15.83 grams per square meter coating of calcium chloride. Two polymeric coatings of polyhydroxybutyrate (PHB) (applied sequentially, for a total of 20 gram per square meter, 20 micron) were applied directly by air atomizing spray nozzle to the coated material with a compostable adhesive. The adhesive used was sourced from a compostable laminating adhesive sold by Scitech

### Adhesive Systems as ST6093G HS.

It was found with this example that the average water vapour transmission rate was 31 g/m²/day (measured at 25 degrees Celsius and at 75% relative humidity), a reduction from a water vapour transmission rate of 3000 g/m²/24 hr (measured at 25 degrees Celsius and at 75% relative humidity) for the uncoated highly porous kraft cellulose-fibre material (125 gram per square meter). The oxygen transmission rate of this packaging material was also measured and the average was calculated as 253 cm³/m²/24 hr.

### Example 11—Kraft Cellulose-Fibre Material Coated with Calcium Chloride (15.83 gsm), Bentonite Clay and Microfibrillated Cellulose (12.93 gsm), and a Polymeric Layer of Polyhydroxybutyrate (20 gsm)

In this example, a sheet of highly porous kraft cellulose-fibre material (125 gram per square meter) was spray coated directly by air atomizing spray nozzle with a solution of calcium chloride and then dried to provide on a dry weight basis a 15.83 grams per square meter coating of calcium chloride. A dispersion of 6 wt % bentonite clay and 1.5 wt % microfibrillated cellulose was then spray coated directly by air atomizing spray nozzle onto the calcium chloride coated material and then dried (the process of spray coating and drying completed three more times) to provide on a dry weight basis a 12.93 grams per square meter coating of bentonite clay and microfibrillated cellulose. A polymeric coating of polyhydroxybutyrate (PHB) (20 gram per square meter, 20 micron) was then applied directly by air atomizing spray nozzle to the coated material with a compostable adhesive. The adhesive used was sourced from a compostable laminating adhesive sold by Scitech Adhesive Systems as ST6093G HS.

It was found with this example that the average water vapour transmission rate was 33 g/m²/24 hr (measured at 25 degrees Celsius and at 75% relative humidity), a reduction from a water vapour transmission rate of 3000 g/m²/24 hr (measured at 25 degrees Celsius and at 75% relative humidity) for the uncoated highly porous kraft cellulose-fibre material (125 gram per square meter). The oxygen transmission rate of this packaging material was also measured and the average was calculated as 287 cm³/m²/24 hr.

### Example 12—Kraft Cellulose-Fibre Material Coated with Insoluble Salt/Soluble Hygroscopic Salt (11.5 gsm)

In this example, calcium chloride, potassium carbonate and phosphoric acid (85% in water) were brought into contact in that sequence to generate carbon dioxide together with an aqueous solution of tricalcium phosphate and potassium chloride (the reaction products). The reaction products solution was spray coated (with the optional addition of water to provide a low viscosity solution) onto a sheet of highly porous kraft cellulose-fibre material (125 gram per square meter) directly by air atomizing spray nozzle which was then dried to provide on a dry weight basis a 11.5 grams per square meter coating of the reaction products.

It was found with this example that the average water vapour transmission rate was between 368 g/m²/day (measured at 25 degrees Celsius and at 75% relative humidity), a significant reduction from a water vapour transmission rate of 3000 g/m²/24 hr (measured at 25 degrees Celsius and at 75% relative humidity) for the uncoated highly porous kraft cellulose-fibre material (125 gram per square meter).

### Example 13—Kraft Cellulose-Fibre Material Coated with SS (11.5 gsm)

In this example, calcium chloride, potassium carbonate and phosphoric acid (85% in water) were reacted together to generate carbon dioxide together with an aqueous solution of tricalcium phosphate and potassium chloride (the reaction products). The reaction products solution was spray coated (with the optional addition of water to provide a low viscosity solution) onto a sheet of highly porous kraft cellulose-fibre material (125 gram per square meter) directly by air atomizing spray nozzle which was then dried to provide on a dry weight basis a 11.5 grams per square meter coating of the reaction products.

It was found with this example that the average water vapour transmission rate was 375 g/m²/day (measured at 25 degrees Celsius and at 75% relative humidity), a significant reduction from a water vapour transmission rate of 3000 g/m²/24 hr (measured at 25 degrees Celsius and at 75% relative humidity) for the uncoated highly porous kraft cellulose-fibre material (125 gram per square meter).

### Example 14—Kraft Cellulose-Fibre Material Coated with WPI Calcium Chloride (20 gsm)

In this example, a sheet of highly porous kraft cellulose-fibre material (125 gram per square meter) was spray coated directly by air atomizing spray nozzle with a solution of whey protein isolate (WPI)/calcium chloride which was then dried to provide on a dry weight basis a 20 grams per square meter coating of WPI calcium chloride.

It was found with this example that the average water vapour transmission rate was 593 g/m²/day (measured at 25 degrees Celsius and at 75% relative humidity), a significant reduction from a water vapour transmission rate of 3000 g/m²/24 hr (measured at 25 degrees Celsius and at 75% relative humidity) for the uncoated highly porous kraft cellulose-fibre material (125 gram per square meter).

### Example 15—Kraft Cellulose-Fibre Material Coated with WPC Calcium Chloride (20 gsm)

In this example, a sheet of highly porous kraft cellulose-fibre material (125 gram per square meter) was spray coated directly by air atomizing spray nozzle with a solution of whey protein ceoncentrate (WPC)/calcium chloride which was then dried to provide on a dry weight basis a 20 grams per square meter coating of WPC calcium chloride.

It was found with this example that the average water vapour transmission rate was 518 g/m²/day (measured at 25 degrees Celsius and at 75% relative humidity), a significant reduction from a water vapour transmission rate of 3000 g/m²/24 hr (measured at 25 degrees Celsius and at 75% relative humidity) for the uncoated highly porous kraft cellulose-fibre material (125 gram per square meter).

As illustrated in Table 1, the water vapour transmission test results show that coating with at least one of calcium chloride, MFC, and a phyllosilicate, provides excellent barrier properties against water vapour permeation through the coating.

Further, it was found that coating with a dispersion of microfibrillated cellulose (such as 1.5 wt %) and bentonite (such as 6 wt %) seemed to drastically improve the ability for a coating to be able to be sprayed onto a surface, compared to the other concentrations and ratios evaluated. Once the dispersion of microfribrillated cellulose and bentonite was applied, there was very little to no orange peel formation from the coating wanting to conglomerate on the surface of the material.

Without wishing to be bound by theory, it is believed that this observed benefit may be due to the negatively charged platelets within the walls of the microfibrillated cellulose fibres being neutralised by the positively charged cation region within the tetrahedral molecular structure of the phyllosilicate particles. This provided a very good neutral coating, hence why it was anticipated to be the perfect mechanically sound layer to host the salt compound.

TABLE 1

| | | First | | Second | |
|---|---|---|---|---|---|
| | | Coat | | Coat | |
| | | weight | | weight | |
| | | (gram | | (gram | |
| | | per | | per | |
| | | square | | square | |
| Sample | First Coat | metre) | Second Coat | metre) | Third Coat |
| Control | Polyhydroxyalkanoates | 25 | | | |
| Example 1 | Bentonite | 11.67 | Calcium chloride | 15.83 | Microfibrillated |
| | | | | | cellulose & Bentonite |
| Example 2 | Bentonite | 11.67 | | | |
| Example 3 | Microfibrillated cellulose | 6.93 | | | |
| Example 4 | Microfibrillated cellulose & | 12.93 | | | |
| | Bentonite | | | | |
| Example 5 | Calcium chloride | 15.83 | | | |
| Example 6 | Calcium chloride | 63.32 | | | |
| Example 7 | Bentonite | 11.67 | Calcium chloride | 15.83 | Microfibrillated |
| | | | | | cellulose & Bentonite |
| Example 8 | Bentonite | 11.67 | Calcium chloride | 15.83 | Microfibrillated |
| | | | | | cellulose |
| Example 9 | Calcium chloride | 15.83 | Microfibrillated | 12.93 | |
| | | | cellulose & Bentonite | | |
| Example 10 | Calcium chloride | 15.83 | Polyhydroxybutyrate | 20 | |
| Example 11 | Calcium chloride | 15.83 | Microfibrillated | 12.93 | Polyhydroxybutyrate |
| | | | cellulose & Bentonite | | |
| Example 12 | Tricalcium phosphate and | 11.5 | | | |
| | potassium chloride | | | | |
| | replicate #1 | | | | |
| Example 13 | Tricalcium phosphate and | 11.5 | | | |
| | potassium chloride | | | | |
| | replicate #2 | | | | |
| Example 14 | WPI/Calcium chloride | 20 | | | |
| Example 15 | WPC/Calcium chloride | 20 | | | |

| | Third | | Fourth | | |
|---|---|---|---|---|---|
| | Coat | | Coat | | Water |
| | weight | | weight | Oxygen | Vapour |
| | (gram | | (gram | Transmission | Transmission |
| | per | | per | rate | rate |
| | square | | square | (cm³/m²/ | (g/m²/ |
| Sample | metre) | Fourth Coat | metre) | 24 hr) | 24 hr) |
| Control | | | | 400 | 115 |
| Example 1 | 4.31 | | | | 1223 |
| Example 2 | | | | | 344 |
| Example 3 | | | | | 681 |
| Example 4 | | | | | 868 |
| Example 5 | | | | | 217 |
| Example 6 | | | | | 255 |
| Example 7 | 4.31 | Polyhydroxyalkanoates | 25 | 747 | 62 |
| | | (eg PHB) | | | |
| Example 8 | 3.2 | | | | |
| Example 9 | | | | | |
| Example 10 | | | | 253 | 31 |
| Example 11 | 20 | | | 287 | 33 |
| Example 12 | | | | | 368 |
| Example 13 | | | | | 375 |
| Example 14 | | | | 200000+ | 593 |
| Example 15 | | | | 200000+ | 518 |

### Water Holding Capacity

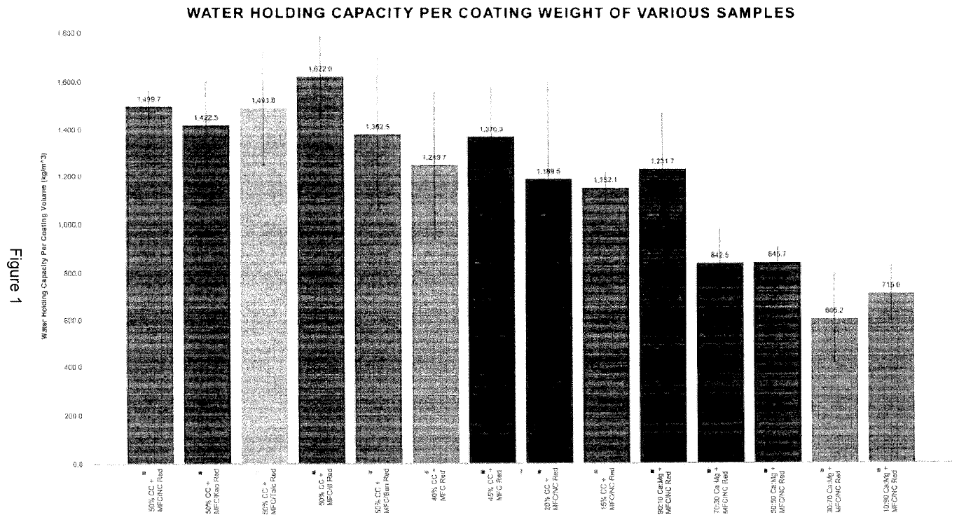

Further coatings were investigated to evaluate the effect of different salts and phyllosilicates on the water holding capacity of the coating with microfibrillated cellulose. The average water holding capacity per coating weight of the examples 16-29 is illustrated in FIG. 1.

### Example 16—Kraft Cellulose-Fibre Material Coated with Microfibrillated Cellulose, Red Bentonite Clay, and Subjected to a 50 wt % Solution of Calcium Chloride

In this example, a sheet of highly porous kraft cellulose-fibre material (125 gram per square meter) was spray coated directly by air atomizing spray nozzle with a dispersion of 1.5 wt % microfibrillated cellulose and 7.7 wt % red bentonite clay. Once dry, the coated material was spray coated directly by air atomizing spray nozzle with a 50 wt % solution of calcium chloride in deionized water, and dried. It was found with this example that the average water holding capacity was 1499.7 kg/m³ (measured at 25 degrees Celsius).

### Example 17—Kraft Cellulose-Fibre Material Coated with Microfibrillated Cellulose, Red Kaolin Clay, and Subjected to a 50 wt % Solution of Calcium Chloride

In this example, a sheet of highly porous kraft cellulose-fibre material (125 gram per square meter) was spray coated directly by air atomizing spray nozzle with a dispersion of 1.5 wt % microfibrillated cellulose, and 11.6 wt % red kaolin clay, and then dried. The coated material was spray coated directly by air atomizing spray nozzle with a 50 wt % solution of calcium chloride in deionized water, and dried. It was found with this example that the average water holding capacity was 1422.5 kg/m³ (measured at 25 degrees Celsius).

### Example 18—Kraft Cellulose-Fibre Material Coated with Microfibrillated Cellulose, Talc, and Subjected to a 50 wt % Solution of Calcium Chloride

In this example, a sheet of highly porous kraft cellulose-fibre material (125 gram per square meter) was spray coated directly by air atomizing spray nozzle with a dispersion of 1.5 wt % microfibrillated cellulose and 7.9 wt % talc, and dried. The coated material was spray coated directly with a 50 wt % solution of calcium chloride in deionized water, and dried. It was found with this example that the average water holding capacity was 1493.8 kg/m³ (measured at 25 degrees Celsius).

### Example 19—Kraft cellulose-fibre material coated with microfibrillated cellulose, red illite clay, and subjected to a 50 wt % solution of calcium chloride

In this example, a sheet of highly porous kraft cellulose-fibre material (125 gram per square meter) was spray coated directly by air atomizing spray nozzle with a dispersion of 1.5 wt % microfibrillated cellulose, and 6.99 wt % red illite clay, and dried. The coated material was spray coated directly by air atomizing spray nozzle with a 50 wt % solution of calcium chloride in deionized water, and dried. It was found with this example that the average water holding capacity was 1622.0 kg/m³ (measured at 25 degrees Celsius).

### Example 20—Kraft Cellulose-Fibre Material Coated with Microfibrillated Cellulose, Ben Red and Subjected to a 50 wt % Solution of Calcium Chloride

In this example, a sheet of highly porous kraft cellulose-fibre material (125 gram per square meter) was spray coated directly by air atomizing spray nozzle with a dispersion of 1.5 wt % microfibrillated cellulose, and 7.7 wt % Ben Red, and dried. The coated material was spray coated directly by air atomizing spray nozzle with a 50 wt % solution of calcium chloride in deionized water, and dried. It was found with this example that the average water holding capacity was 1382.5 kg/m³ (measured at 25 degrees Celsius).

### Example 21—Kraft Cellulose-Fibre Material Coated with Microfibrillated Cellulose, Red Bentonite Clay and Subjected to a 40 wt % Solution of Calcium Chloride

In this example, a sheet of highly porous kraft cellulose-fibre material (125 gram per square meter) was spray coated directly by air atomizing spray nozzle with a dispersion of 1.5 wt % microfibrillated cellulose, and 7.7 wt % red bentonite clay, and dried. The coated material was spray coated directly by air atomizing spray nozzle with a 40 wt % solution of calcium chloride in deionized water, and dried. It was found with this example that the average water holding capacity was 1249.7 kg/m³ (measured at 25 degrees Celsius).

### Example 22—Kraft Cellulose-Fibre Material Coated with Microfibrillated Cellulose, Red Bentonite Clay and Subjected to a 45 wt % Solution of Calcium Chloride

In this example, a sheet of highly porous kraft cellulose-fibre material (125 gram per square meter) was spray coated directly by air atomizing spray nozzle with a dispersion of 1.5 wt % microfibrillated cellulose, and 7.7 wt % red bentonite clay, and dried. The coated material was spray coated directly by air atomizing spray nozzle with a 45 wt % solution of calcium chloride in deionized water, and dried. It was found with this example that the average water holding capacity was 1370.3 kg/m³ (measured at 25 degrees Celsius).

### Example 23—Kraft Cellulose-Fibre Material Coated with Microfibrillated Cellulose, Red Bentonite Clay and Subjected to a 20 wt % Solution of Calcium Chloride

In this example, a sheet of highly porous kraft cellulose-fibre material (125 gram per square meter) was spray coated directly by air atomizing spray nozzle with a dispersion of 1.5 wt % microfibrillated cellulose, and 7.7 wt % red bentonite clay, and dried. The coated material was spray coated directly by air atomizing spray nozzle with a 20 wt % solution of calcium chloride in deionized water, and dried. It was found with this example that the average water holding capacity was 1189.5 kg/m³ (measured at 25 degrees Celsius).

### Example 24—Kraft Cellulose-Fibre Material Coated with Microfibrillated Cellulose, Red Bentonite Clay and Subjected to a 15 wt % Solution of Calcium Chloride

In this example, a sheet of highly porous kraft cellulose-fibre material (125 gram per square meter) was spray coated directly by air atomizing spray nozzle with a dispersion of 1.5 wt % microfibrillated cellulose, and 7.7 wt % red bentonite clay, and dried. The coated material was spray coated directly by air atomizing spray nozzle with a 15 wt % solution of calcium chloride in deionized water, and dried. It was found with this example that the average water holding capacity was 1152.1 kg/m³ (measured at 25 degrees Celsius).

### Example 25—Kraft Cellulose-Fibre Material Coated with Microfibrillated Cellulose, Red Bentonite Clay and Subjected to a Solution of 45 wt % Calcium Chloride and 5 wt % Wt Magnesium Sulfate

In this example, a sheet of highly porous kraft cellulose-fibre material (125 gram per square meter) was spray coated directly by air atomizing spray nozzle with a dispersion of 1.5 wt % microfibrillated cellulose, and 7.7 wt % red bentonite clay, and dried. The coated material was spray coated directly by air atomizing spray nozzle with a solution of 45 wt % calcium chloride and 5 wt % magnesium sulfate in deionized water, and dried. It was found with this example that the average water holding capacity was 1231.7 kg/m³ (measured at 25 degrees Celsius).

### Example 26—Kraft Cellulose-Fibre Material Coated with Microfibrillated Cellulose, Red Bentonite Clay and Subjected to a Solution of 35 wt % Calcium Chloride and 15 wt % Magnesium Sulfate

In this example, a sheet of highly porous kraft cellulose-fibre material (125 gram per square meter) was spray coated directly by air atomizing spray nozzle with a dispersion of 1.5 wt % microfibrillated cellulose and 7.7 wt % red bentonite clay, and dried. The coated material was spray coated directly by air atomizing spray nozzle with a solution of 35 wt % calcium chloride and 15 wt % magnesium sulfate in deionized water, and dried.

It was found with this example that the average water holding capacity was 842.5 kg/m³ (measured at 25 degrees Celsius).

### Example 27—Kraft Cellulose-Fibre Material Coated with Microfibrillated Cellulose, Red Bentonite Clay and Subjected to a Solution of 25 wt % Calcium Chloride and 25 wt % Magnesium Sulfate

In this example, a sheet of highly porous kraft cellulose-fibre material (125 gram per square meter) was spray coated directly by air atomizing spray nozzle with a dispersion of 1.5 wt % microfibrillated cellulose and 7.7 wt % red bentonite clay, and dried. The coated material was spray coated directly by air atomizing spray nozzle with a solution of 25 wt % calcium chloride and 25% wt magnesium sulfate in deionized water, and dried. It was found with this example that the average water holding capacity was 845.7 kg/m³ (measured at 25 degrees Celsius).

### Example 28—Kraft Cellulose-Fibre Material Coated with Microfibrillated Cellulose, Red Bentonite Clay and Subjected to a Solution of 15 wt % Calcium Chloride and 35 wt % Magnesium Sulfate

In this example, a sheet of highly porous kraft cellulose-fibre material (125 gram per square meter) was spray coated directly by air atomizing spray nozzle with a dispersion of 1.5 wt % microfibrillated cellulose, 7.7 wt % red bentonite clay, and dried. The coated material was spray coated directly by air atomizing spray nozzle with a solution of 15 wt % calcium chloride and 35% wt magnesium sulfate in deionized water, and dried. It was found with this example that the average water holding capacity was 606.2 kg/m³ (measured at 25 degrees Celsius).

### Example 29—Kraft Cellulose-Fibre Material Coated with Microfibrillated Cellulose, Red Bentonite Clay and Subjected to a Solution of 5 wt % Calcium Chloride and 45 wt % Magnesium Sulfate

In this example, a sheet of highly porous kraft cellulose-fibre material (125 gram per square meter) was spray coated directly by air atomizing spray nozzle with a dispersion of 1.5 wt % microfibrillated cellulose and 7.7 wt % red bentonite clay, and dried. The coated material was spray coated directly by air atomizing spray nozzle with a solution of 5 wt % calcium chloride and 45 wt % magnesium sulfate in deionized water, and dried. It was found with this example that the average water holding capacity was 715.0 kg/m³ (measured at 25 degrees Celsius).

### Water Holding Efficiency

The effect of the concentration of calcium chloride content on the water holding capacity of the coatings comprising microfibrillated cellulose, and both bentonite and microfibrillated cellulose was evaluated.

### Example 30—Kraft Cellulose-Fibre Material Coated with Microfibrillated Cellulose and Subjected a Calcium Chloride Treatment

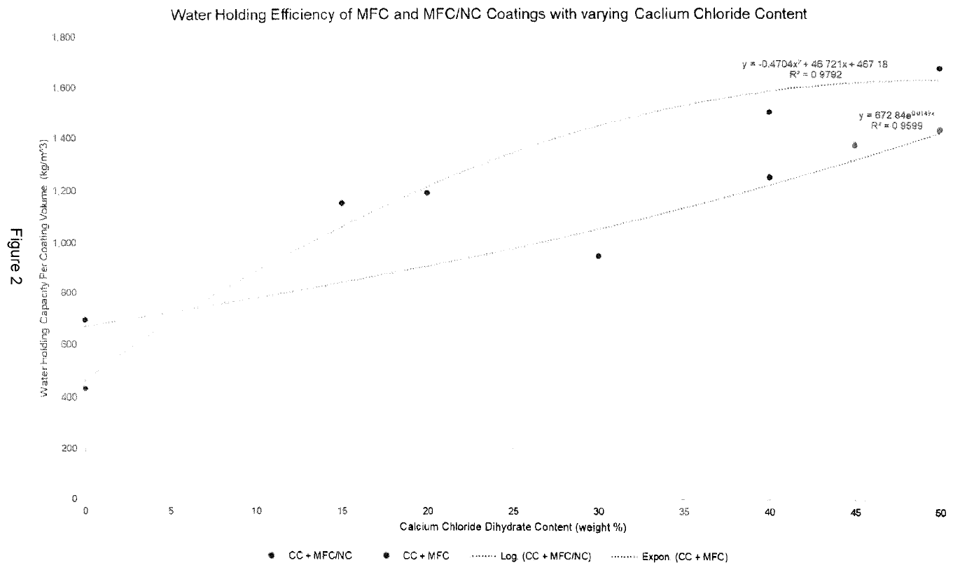

In this example, five sheets of highly porous kraft cellulose-fibre material (125 gram per square meter) were spray coated directly with a dispersion of 1.5 wt % microfibrillated cellulose and dried. The coated materials were spray coated directly with a solution of either deionized water, or a solution of 40% and 45% calcium chloride in deionized water, and dried. As illustrated in FIG. 2, it was found with that the water holding capacities were 1,249.7 and 1,370.3 kg/m³, respectively, measured at 25 degrees Celsius.

### Example 31—Kraft Cellulose-Fibre Material Coated with Microfibrillated Cellulose and Red Bentonite Clay, and Subjected a Calcium Chloride Treatment

In this example, five sheets of highly porous kraft cellulose-fibre material (125 gram per square meter) were spray coated directly by air atomizing spray nozzle with a dispersion of 1.5 wt % microfibrillated cellulose and 7.7 wt % red bentonite and dried. The coated materials were spray coated directly with a solution of either deionized water, or a solution of 15%, 20% or 50% calcium chloride in deionized water, and dried. As illustrated in FIG. 2, it was found with that the water holding capacities were 1,152.1, 1,370.3, 1,499.7 kg/m³, respectively, measured at 25 degrees Celsius.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The technology may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the technology and without diminishing its attendant advantages. It is therefore intended that such changes and modifications be included within the present technology.

1. A material including a matrix of fibres, the matrix including at least one of the following:
i. a hygroscopic salt which is adsorbed onto the surface of the fibres, the hygroscopic salt being water soluble;
ii. a phyllosilicate mineral; and
iii. a cellulosic particle which can be entrained within the matrix.

2. The material according to claim 1 wherein the cation of the hygroscopic salt is selected from: calcium; magnesium; aluminium; potassium; sodium; zinc; and lithium.

3. The material according to claim 2 wherein the anion of the hygroscopic salt is selected from: chloride; sulphate; carbonate; and nitrate.

4. The material according to any one of claims 1 to 3 wherein the hygroscopic salt is selected from: calcium chloride; magnesium chloride; aluminium sulphate; calcium nitrate; potassium nitrate; potassium carbonate; sodium nitrate; and sodium chloride; and combinations thereof.

5. The material according to any one of claims 1 to 4 wherein the hygroscopic salt is selected from: calcium chloride; magnesium chloride; aluminium sulphate; and calcium nitrate; and combinations thereof.

6. The material according to any one of claims 1 to 5 wherein the phyllosilicate mineral is selected from: a kaolinite; talc; illite; and a bentonite; and combinations thereof.

7. The material according to any one of claims 1 to 6 wherein the cellulosic particle is selected from: a micro-fibrillated cellulose; microcrystalline cellulose; and nano-structured cellulose; and combinations thereof.

8. The material according to any one claims 1 to 7 which is a packaging material.

9. The material according to any one of claims 1 to 8 including the hygroscopic salt and further including at least one of:
i. a phyllosilicate mineral; and
ii. a cellulosic particle which can be entrained within the matrix.

10. The material according to any one of claims 1 to 9 including the hygroscopic salt and further including each of:
i. a phyllosilicate mineral; and
ii. a cellulosic particle which can be entrained within the matrix.

11. The material according to any one of claims 1 to 10 wherein the hygroscopic salt is calcium chloride.

12. The material according to any one of claims 1 to 11 wherein the hygroscopic salt is provided at from 5 to 100 grams per square metre surface area of the material.

13. The material according to any one of claims 1 to 12 wherein the phyllosilicate mineral is red bentonite.

14. The material according to any one of claims 1 to 13 wherein the phyllosilicate mineral is provided at from 5 to 25 grams per square metre surface area of the material.

15. The material according to any one of claims 1 to 14 wherein the cellulosic particle is micro-fibrillated cellulose.

16. The material according to any one of claims 1 to 15 wherein the particle is provided at from 5 to 25 grams per square metre surface area of the material.

17. A coating system for applying to a material including a matrix of fibres to decrease moisture vapour transmission across said material, the coating system including at least two of the following compositions:
a composition including: a hygroscopic salt which is water soluble; and a first carrier;
a composition including: a phyllosilicate mineral; and a second carrier; and
a composition including: a cellulosic particle which can be entrained within the matrix; and a third carrier.

18. The coating system according to claim 17 wherein at least one of the first carrier, second carrier, and third carrier is an aqueous solvent.

19. The coating system according to claim 17 or claim 18 wherein at least one of the first carrier, second carrier, and third carrier is water.

20. The coating system according to any one of claims 17 to 19 wherein: the hygroscopic salt is calcium chloride; the phyllosilicate mineral is selected from a kaolinite, talc, illite, or a bentonite; and the particle is micro-fibrillated cellulose.

21. A method of treating a material including a matrix of fibres to decrease moisture vapour transmission across said material, the method including the steps of:
i. providing a material including a matrix of fibres;
ii. applying a first composition to the material, the composition including a first carrier and at least one of:
a. a hygroscopic salt which is water soluble;
b. a phyllosilicate mineral; and
c. a cellulosic particle which can be entrained within the matrix;
iii. removing at least a portion of the first carrier from the material.

22. The method according to claim 21 further including a coating step which includes the steps of:
i. applying a second composition to the material to which the first composition has been applied, the composition including a second carrier and at least one of:
a. a polymer;
b. a hygroscopic salt which is water soluble;
c. a phyllosilicate mineral; and
d. a cellulosic particle which can be entrained within the matrix;
ii. removing at least a portion of the second carrier from the material.

23. The method according to claim 21 or claim 22 wherein the hygroscopic salt is calcium chloride.

24. The material according to any one of claims 21 to 23 wherein the hygroscopic salt is applied at from 5 to 100 grams per square metre surface area of the material.

25. The material according to any one of claims 21 to 24 wherein the phyllosilicate mineral is selected from a kaolinite, talc, illite, or a bentonite.

26. The material according to any one of claims 21 to 25 wherein the phyllosilicate mineral is red bentonite.

27. The material according to any one of claims 21 to 26 wherein the phyllosilicate mineral is applied at from 5 to 25 grams per square metre surface area of the material.

28. The material according to any one of claims 21 to 27 wherein the cellulosic particle is micro-fibrillated cellulose.

29. The material according to any one of claims 21 to 28 wherein the cellulosic particle is applied at from 5 to 25 grams per square metre surface area of the material.

30. The method according to any one of claims 21 to 29 wherein at least one of the first carrier and second carrier is an aqueous solvent.

31. The method according to any one of claims 21 to 30 wherein at least one of the first carrier and second carrier is water.

32. A package being formed, at least in part, from a packaging material, the packaging material including a matrix of fibres, the matrix including at least one of the following:
i. a hygroscopic salt which is adsorbed onto the surface of the fibres, the hygroscopic salt being water soluble;
ii. a phyllosilicate mineral; and
iii. a cellulosic particle which can be entrained within the matrix.

33. The package according to claim 32 wherein the hygroscopic salt is calcium chloride.

34. The package according to claim 32 or claim 33 wherein the hygroscopic salt is provided at from 5 to 100 grams per square metre surface area of the material.

35. The package according to any one of claim 32 to claim 34 wherein the phyllosilicate mineral is selected from a kaolinite, talc, illite, or a bentonite.

36. The package according to any one of claims 32 to 35 wherein the phyllosilicate mineral is red bentonite.

37. The package according to any one of claims 32 to 36 wherein the phyllosilicate mineral is provided at from 5 to 25 grams per square metre surface area of the material.

38. The package according to any one of claims 32 to 37 wherein the cellulosic particle is micro-fibrillated cellulose.

39. The package according to any one of claims 32 to 38 wherein the cellulosic particle is provided at from 5 to 25 grams per square metre surface area of the material.

40. The package according to any one of claims 32 to 39 further including an additional layer of a polymer at an extremity of the material that is internal to the package.

41. The package according to claim 40 wherein the polymer is a biodegradable polymer.

42. The package according to claim 41 wherein the biodegradable polymer is polyhydroxybutyrate (PHB).

43. The package according to any one of claims 32 to 42 which is biodegradable.

44. The package according to any one of claims 32 to 43 which is compostable.

45. The package according to any one of claims 32 to 44 which is compostable under non-industrial composting conditions.
